(19) United States
(12) Patent Application Publication
(10) Pub. No.: US 2004/0130112 A1
(43) Pub. Date: Jul. 8, 2004

(54) One-wheeled collapsible deer drag

(76) Inventor: Keith A. Doyle, York, PA (US)

Correspondence Address: Sanford J. Piltch, Esq., Suite 201, 1132 Hamilton Street, Allentown, PA, 18101, US

(21) Appl. No.: 10/337,442

(22) Filed: Jan. 7, 2003

(51) Int. Cl. B62B 1/00

(52) U.S. Cl. 280/47.26

(57) ABSTRACT

A simple collapsible lightweight single-wheeled game transporting cart which may be carried as a backpack in its collapsed state, the cart being easily expanded and deployed in the dark and in adverse outdoor weather conditions, the cart further including a stable and rugged design and having integral means for securing game, enabling one person to remove a killed game carcass from a remote hunting location by dragging and maneuvering the loaded deployed cart across rough and wooded terrain.

### BACKGROUND OF THE INVENTION

The present invention relates to wheeled devices for use by hunters in transporting heavy game from remote areas with rough and wooded terrain where there is no motor vehicle access. More specifically, the present invention relates to a simple, collapsible, lightweight, single-wheeled game transporting device easily carried into a remote area by one person when empty and facilitating removal of a killed game carcass out of a remote area by one person when deployed.

The use of a game transporting device is known in the prior art. While many prior configurations have been devised for the purpose of transporting game carcasses, each possesses disadvantages that are overcome in the present invention. Some of the earlier devices that are described below are generically referred to as carts, while others are combinations of devices useful to a hunter, such as a combined tree stand and cart, or a combined ladder and cart. Common disadvantages of these devices include the use of a large wheel creating a high center of gravity, and thus instability in the fully loaded game transporting cart; bulky construction making the cart heavy and large in size, and thus not easily transportable into a remote area; the use of two wheels making it more difficult to navigate and turn the cart across uneven terrain and between obstacles; complexity of assembly making the cart more difficult to deploy in the dark or in adverse outdoor weather conditions; and, the lack of integral means for securing game to the cart.

One of these earlier devices described in U.S. Pat. No. 3,907,323 [Knapp et al.] teaches a single-wheeled game cart with a large centrally located wheel. This game cart is not collapsible for carrying by one person, and is preferably designed for two person operation when deployed to carry game. Further, this cart does not include integral means for securing the killed game to the cart.

Another device described in U.S. Pat. No. 4,063,744 [Fraser] discloses a single-wheeled symmetric collapsible game cart with a large centrally located wheel. While this cart is designed to be collapsed for transporting in a motor vehicle, it is not designed for carrying by a person, as it weighs a relatively heavy 45 pounds. Further, it is designed for two person operation when deployed to carry game.

U.S. Pat. No. 5,620,193 [Dschaak] describes a single-wheeled game cart, also with a large centrally located wheel. While designed for one person operation, this cart is of relatively heavy construction and is not collapsible for ease of transporting when not in use.

Another patent, U.S. Pat. No. 5,820,141 [Wilkerson et al.], discloses a game cart utilizing a single centrally located cylindrical inflatable roller. While this cart may be disassembled into a multitude of pieces for transporting in a conventional backpack, assembly of the pieces and inflation of the roller introduces complexity and renders this cart more difficult to use than the present invention. Additionally, the inflatable roller may be susceptible to puncture and the width of the roller makes this device more akin to a two-wheeled cart than a single-wheeled cart as far as maneuverability over and through rough, wooded terrain.

U.S. Pat. No. 5,564,720 [Stringer] also describes a two-wheeled game cart. While this cart is lightweight and collapsible, it requires a separate harness, included as part of the invention, to be attached to the cart for purposes of carrying the cart as one would a backpack. Further, this device lacks integral means for securing game to the cart.

Other two-wheeled game carts exist in earlier patents that are designed to be collapsed or disassembled to facilitate transport of the empty cart. These include U.S. Pat. No. 5,673,928 [Jury], U.S. Pat. No. 6,218,043 [Chumley], and U.S. Pat. Nos. 6,142,491, 6,164,671, and 6,270,092 [Darling III]. In addition to the disadvantages presented by the two-wheeled design, each of the described devices is more cumbersome, more complex to operate, and heavier than the present invention.

A number of other devices have been described in earlier patents that combine the functionality of a tree stand, or tree climbing ladder with that of a game cart. These include U.S. Pat. No. 4,321,982 [Strickland], U.S. Pat. No. 4,373,737 [Cory et al.], U.S. Pat. No. 5,105,908 [Freund], U.S. Pat. No. 5,242,030 [Lobozzo], U.S. Pat. No. 5,295,556 [Mullin], U.S. Pat. No. 5,492,196 [Michno], and U.S. Pat. No. 5,433,291 [Shoestock, Sr.]. Each of these incorporates either two wheels or a roller and is more cumbersome, more complex to operate, and heavier than the present invention.

Accordingly, it is an aspect of the present invention to provide a game transporting apparatus that has a low center of gravity and thus is stable when loaded with game. It is also an aspect of the present invention to provide a game transporting apparatus that is easily navigated over rough and wooded terrain. It is a further aspect of the present invention to provide integral means for securing a game carcass to the game transporting apparatus.

It is also a further aspect of the present invention to provide a game transporting apparatus that is small in size and light in weight so that it is easily carried as a backpack when collapsed. It is still a further aspect of the present invention to provide a game transporting apparatus that is of a simple collapsible design that may easily be assembled in the dark or in adverse outdoor weather conditions.

Other aspects of the invention will appear hereinafter.

### SUMMARY OF THE INVENTION

The present invention overcomes the foregoing disadvantages inherent in the known types of game carts existing in the prior art. The present invention provides a maneuverable and rugged game cart that is light in weight and collapsible and can be carried as a backpack. Further, the present invention is a simple and easily assembled game cart that provides integral means for securing game and is stable when fully loaded. These aspects, and others expressed or implied in this document, are accomplished by the present invention.

The present invention is designed particularly for use in the transport of deer or other like-sized game out of a remote hunting area, but its use need not be restricted to that application. The present invention essentially comprises a collapsible and portable hand cart which includes a three-section hinged foldable frame, a small single wheel disposed at one end and a pair of handles disposed at the other end.

In the fully extended and deployed state, the deer drag game cart has a ladder-like frame on which game can be loaded and supported. The extended frame is essentially trapezoidal in shape, with the side rails being spaced closer together at the distal end where the wheel is attached and tapering to a wider spacing at the proximal end where the handles are connected. When the frame is extended and game is mounted on the frame, the hinges are rigidly locked into position by the weight of the game and the frame acts as one unit to provide support for the game. A removable support strap in the middle frame section provides added support for the game and can be removed to improve the collapsibility of the frame. The frame includes a plurality of integral straps for securing the game. A retractable bottom support plate is provided to prevent game from sliding down off the distal end of the cart. The dual position handles can be rotated to clear the hips of a person pulling the cart from the front. The curvature of the handles provides for a good gripping position to control the movement of the cart. With the wheel disposed at the distal end of the cart, the handles can be held at any height, and thus the cart is automatically adaptable to a person of any height. The handles perform equally well for a person restraining the cart from behind as it is lowered down a slope.

In the fully collapsed state, the deer drag game cart is reduced to approximately one-third of its extended length and the frame resembles that of a backpack frame. The retractable bottom support plate is folded in against the lower frame section. The lower frame section is folded backwards over the middle frame section and the removable support strap in the middle frame section is removed to allow the wheel to tuck neatly inside and away from the back of the person carrying the collapsed cart. The upper frame section is folded backwards over the middle frame section. The game securing straps are used to secure the cart in the fully collapsed position. The dual position handles are rotated by 180 degrees so that the spacing is narrow enough to fit the shoulders of a person and the curvature of the handles provides a shoulder harness to enable the cart to be carried as a backpack. The removable support strap is used to secure the cart around the chest of a person while it is being carried. Weighing less than 12 pounds, the cart is easily transportable in the collapsed configuration.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a side elevation view of the deer drag of the present invention extended for use in transporting a game carcass.

FIG. 2 is a side view of the deer drag of the present invention showing the movement capabilities of various components of the deer drag.

FIG. 3 is a top view of the deer drag of the present invention showing the various positions of the handles for use in transporting a game carcass or in carrying the collapsed deer drag.

FIG. 4 is a side view of the deer drag of the present invention showing the deer drag collapsed for carrying.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

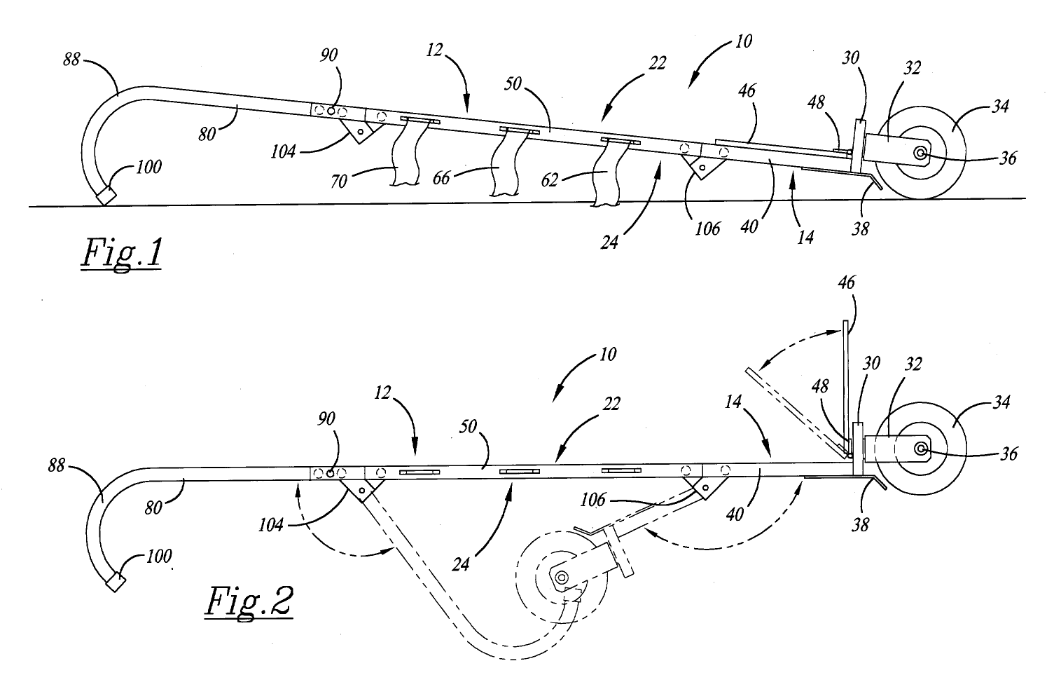

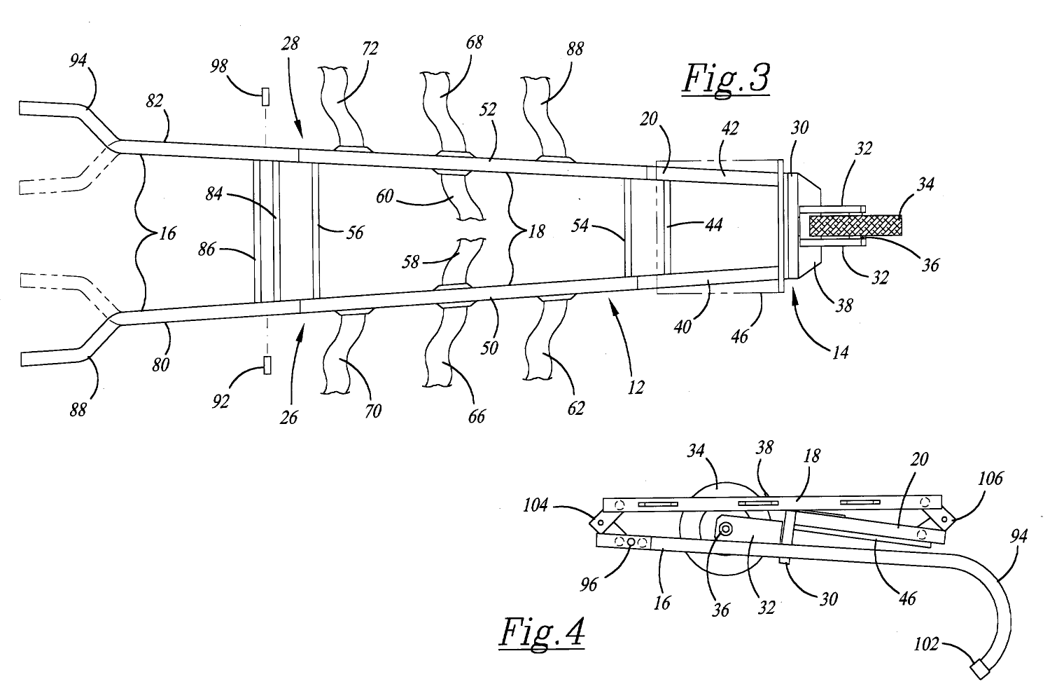

Referring now to the drawings in detail, where like numerals refer to like parts or elements, there is shown in FIGS. 1, 3, and 4 the one-wheeled collapsible deer drag apparatus 10 of the present invention. In the deployed state illustrated in FIG. 1 and FIG. 3, the deer drag 10 is fully extended for transporting game, and in the collapsed state illustrated in FIG. 4, the deer drag 10 is reduced to a configuration which makes it easily carried as a backpack.

With reference to FIG. 3, the deer drag 10 is comprised of a frame portion generally shown as 12 and a wheel portion generally shown as 14. Frame portion 12, which is symmetrical about its right and left sides, is constructed of rigid tubing, solid members, and hinges Which are interconnected by welding, brazing, riveting, or the like. Frame portion 12 is connected to wheel portion 14 at its distal end. The frame portion 12 is roughly trapezoidal in shape such that frame right side 26 and frame left side 28 are closer together at the distal end (nearer the wheel portion 14) and expand apart at the proximal end. As shown in FIG. 1, when apparatus 10 is deployed, frame portion 12 has a front side 22 which faces upward for receiving a game carcass and a rear side 24, which faces downward towards the ground.

Functionally, frame portion 12 is divided into an upper frame section 16 located at the proximal end thereof, a middle frame section 18, and a lower frame section 20 located at the distal end thereof. The upper frame section 16 is connected to the middle frame section 18 by a pair of unidirectional hinges 104 which provide for an extended position whereby upper frame section 16 and middle frame section 18 are essentially coplanar, and a collapsed position whereby upper frame section 16 and middle frame section 18 are doubled over each other in a nearly parallel position with rear sides facing inwards and front sides facing outwards. Similarly, the lower frame section 20 is connected to the middle frame section 18 by a pair of unidirectional hinges 106 which provide for an extended position whereby lower frame section 20 and middle frame section 18 are essentially coplanar, and a collapsed position whereby lower frame section 20 and middle frame section 18 are doubled over each other in a nearly parallel position with rear sides facing inwards and front sides facing outwards. Referring to the fully collapsed state of deer drag apparatus 10, as shown in FIG. 4, lower frame section 20 is first doubled over about hinges 106 with wheel portion 14 tucked inside middle frame section 18 and then upper frame section 20 is doubled over about hinges 104 resulting in the overall collapsed length of the deer drag apparatus 10 being approximately no longer than the length of the middle frame section 18.

The detailed construction of each frame section is best viewed in FIG. 3 with references made to other illustrations where appropriate. Wheel portion 14 is comprised of wheel 34 mounted on axle 36 that is supported on each end by one of a pair of vertical uprights 32. Since such wheel and axle assemblies are common, it is believed unnecessary to show the details of this assembly. The top end of each of the vertical uprights 32 is connected to rigid plate 30 with sufficient structural integrity to support the weight of the deer drag apparatus 10 on wheel 34 when the apparatus 10 is fully loaded with a game carcass. Rigid plate 30 forms the bottom cross support member of the lower frame section 20.

The lower frame section 20 is comprised of lower right rail 40 and lower left rail 42, connected at the bottom ends thereof by rigid plate 30 and near the top ends thereof by cross member 44. Rigid members 40, 42, 30, 44, form a rigid structure capable of supporting the weight of a game carcass and also capable of transmitting force from the middle frame section 18 to the wheel portion 14. Further comprising lower frame section 20 is game support plate 46 connected by hinge 48 to the top side of rigid plate 30. As shown in FIG. 2, game support plate 46 has a stowed position wherein it rests against lower rails 40, 42, and a deployed position wherein it extends outward perpendicular to the front side of lower frame section 20 so as to prevent a game carcass from sliding off the distal end of the deer drag apparatus 10. Additionally, connected to the rear side of lower frame section 20 is wheel kick plate 38 extending down behind wheel portion 14 so as to protect wheel 34 from becoming damaged or entangled when apparatus 10 is being dragged across rough and wooded terrain.

The middle frame section 18 is comprised of middle right rail 50 and middle left rail 52, connected near the bottom ends thereof by cross member 54 and near the top ends thereof by cross member 56. Rigid members 50, 52, 54, 56, form a rigid structure capable of supporting the weight of a game carcass and also capable of transmitting force from the upper frame section 16 to the lower frame section 20. Supporting straps 58, 60 attached to the middle portion of rails 50, 52 respectively connect together to form a cross member capable of bearing a portion of the load of a game carcass. Straps 58, 60 are also used to form a securing means across the chest of a person carrying the collapsed deer drag apparatus 10 as a backpack. Three sets of straps are provided to secure a game carcass to the deployed apparatus 10. Lower securing straps 62, 64 attached to the lower portion of rails 50, 52 respectively connect together around the lower body and hind legs of the game carcass. Middle securing straps 66, 68 attached to the middle portion of rails 50, 52 respectively connect together around the upper body and front legs of the game carcass. Upper securing straps 70, 72 attached to the upper portion of rails 50, 52 respectively connect together around the neck of the game carcass. In the preferred embodiment, straps 58, 60, 62, 64, 66, 68, 70, 72 are matched pairs of hook and loop type fasteners although other equivalent well-known fasteners, for example clip type lo fasteners with adjustable straps as commonly used on backpacks, may be used. Straps 58, 60, 62, 64, 66, 68, 70, 72 may be attached to rails 50, 52 by various means, separately or in combination, including self-stitched loops, self-riveted loops, adhesive, mechanical anchoring, or any equivalent.

As shown in FIG. 2, the middle frame section 18 and the lower frame section 20 are movably connected with one rotational degree of freedom by hinge pair 106. In the extended position about hinge pair 106, the top ends of lower rails 40, 42 and the bottom ends of middle rails 50, 52 butt together respectively in compression such that lower right rail 40 and middle right rail 50 are essentially collinear and lower left rail 42 and middle left rail 52 are also essentially collinear. The rigidity and structural integrity of the extended position about hinge pair 106 enables the middle frame section 18 and the lower frame section 20 to work together as a single unit to support a load strapped to the front side thereof. In the collapsed position about hinge pair 106, the lower frame section 20 is rotated with respect to the middle frame section 18 by approximately 180 degrees with wheel 34 protruding through the open space in the middle frame section 18 from the rear side thereof to the front side thereof such that wheel 34 will not impinge upon the back of a person carrying collapsed apparatus 10 as a backpack, as shown in FIG. 4.

The upper frame section 16 is comprised of upper right rail 80 and upper left rail 82, connected near the bottom ends thereof by cross member 84 and near the top ends thereof by cross member 86. The rigid members 80, 82, 84, 86, form a rigid structure capable of supporting the weight of a game carcass and also capable of transmitting force from handles 88, 94 to the middle frame section 18. Right handle 88 inserts telescopically into the proximal end of upper right rail 80 and is secured through positioning hole 90 using positioning pin 92. Likewise, left handle 94 inserts telescopically into the proximal end of upper left rail 82 and is secured through positioning hole 96 using positioning pin 98.

The handles 88, 94 are shaped in the transverse direction, as shown in FIG. 3, to provide for the dual functionality of collapsed and deployed positions. For transporting a game carcass, handles 88, 94 are secured in the deployed position, shown by solid lines in FIG. 3, which position spreads handles 88, 94 wide enough apart to clear the hips of a person dragging the deployed deer drag apparatus 10 from the front with hands and arms extended rearward or lowering deployed apparatus 10 down a slope from behind with hands and arms extended frontward. For carrying the empty apparatus 10, handles 88, 94 are rotated by 180 degrees and secured in the collapsed position, shown by phantom lines in FIG. 3, which position spaces handles 88, 94 close enough together to allow for convenient carrying of the collapsed apparatus 10 over the shoulders of a person in a manner similar to a backpack, as shown in FIG. 4.

Handles 88, 94 are shaped in the lengthwise direction, as shown in FIG. 1, providing a suitable gripping location for a person using deployed apparatus 10 to transport a game carcass and a suitable shape for carrying the empty apparatus 10 on the shoulders of a person. End caps 100, 102 cover the end of handles 88, 94 to prevent injury to a person operating apparatus 10.

As shown in FIG. 2, the upper frame section 16 and the middle frame section 18 are movably connected with one rotational degree of freedom by hinge pair 104. In the extended position about hinge pair 104, the top ends of middle rails 50, 52 and the bottom end of upper rails 80, 82 butt together respectively in compression such that middle right rail 50 and upper right rail 80 are essentially collinear and middle left rail 52 and upper left rail 82 are also essentially collinear. The rigidity and structural integrity of the extended position about hinge pair 104 enables upper frame section 16 and middle frame section 18 to work together as a single unit to support a load strapped to the front side thereof. In the collapsed position about hinge pair 104, upper frame section 16 is rotated with respect to middle frame section 18 by approximately 180 degrees whereby handles 88, 94 in the collapsed positions thereof are suitable for the carrying of the collapsed deer drag apparatus 10 as a backpack, as shown in FIG. 4.

When the apparatus 10 is collapsed for carrying as a backpack, handles 88, 94 are turned inward in the collapsed positions thereof, game support plate 46 is rotated about hinge 48 into the stowed position thereof, lower frame section 20 is rotated about hinge pair 106 into the collapsed position thereof, upper frame section 16 is rotated about hinge pair 104 into the collapsed position thereof. The straps 62, 64, 66, 68, 70, 72 secure the upper frame section, the middle frame section, and the lower frame section to each other in the collapsed position, handles 88, 94 rest on the shoulders of a person carrying apparatus 10, and straps 58, 60 are secured about the chest of that same person.

When the apparatus 10 is deployed for transporting game out of a remote location, handles 88, 94 are turned outward in the deployed positions thereof, lower frame section 20 is rotated about hinge pair 106 in the extended position thereof, upper frame section 16 is rotated about hinge pair 104 in the extended position thereof, game support plate 46 is rotated about hinge 48 in deployed position thereof. The support straps 58, 60 are secured to each other across middle frame section 18, and apparatus 10 is positioned on the ground with the front side 22 of frame portion 12 facing upwards to receive game. When a game carcass is loaded onto the deployed apparatus 10, straps 62, 64 secure the lower end and hind legs of the carcass to frame portion 12, straps 66, 68 secure the upper body and front legs of the carcass to frame portion 12, straps 70, 72 secure the neck of the carcass to frame portion 12, game support plate 46 prevents the carcass from sliding off the distal end of apparatus 10, and the weight of the game carcass maintains the cooperation of frame sections 16, 18, and 20 as a single rigid extended frame portion 12.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A collapsible and portable hand operated cart, said cart comprising a generally trapezoidal shaped frame having an upper frame section, a middle frame section, a lower frame section, an upper set of unidirectional rearward pivoting hinges connecting said upper frame section to said middle frame section, and a lower set of unidirectional rearward pivoting hinges connecting said middle frame section to said lower frame section; said upper frame section including a pair of generally U-shaped handles adapted to be rotatably positioned at the proximal end thereof and capable of facing frontward to function as handles or facing rearward to function as shoulder harnesses, and a pair of positioning means adapted for securing said handles in a fixed position thereto; said middle frame section including at least one set of supporting straps for supporting objects which have been loaded onto said frame and a plurality of securing straps for securing objects to said frame; said lower frame section including a wheel assembly rigidly mounted at the distal end thereof, a retractable support plate attached by a hinge to the distal end thereof, and a wheel kick plate attached to the rear side thereof and extending behind said wheel assembly.

2. The cart according to claim 1, whereby said handles are secured by said positioning means to be facing frontward providing a gripping means, said upper frame section is pivoted about said upper hinges to be rigidly positioned essentially coplanar with respect to said middle frame section, said lower frame section is pivoted about said lower hinges to be rigidly positioned essentially coplanar with respect to said middle frame section, and said support plate is pivoted about said hinge to extend frontward from said lower frame section.

3. The cart according to claim 2, wherein said support straps are disposed across said middle frame section to provide weight bearing support, a game carcass is positioned on the front of the cart, and said securing straps are disposed around the carcass, thereby enabling the cart to be used to transport the game carcass from a remote area across rough and wooded terrain.

4. The cart according to claim 1, whereby said support plate is pivoted about said hinge to retract into said lower frame section, said lower frame section is pivoted rearward about said lower hinges to be in a collapsed position essentially parallel with respect to said middle frame section, said upper frame section is pivoted rearward about said upper hinges to be in a collapsed position essentially parallel with respect to said middle frame section, said handles are secured by said positioning means to be facing rearward providing a shoulder harness means, said securing straps are disposed around the collapsed cart securing said collapsed frame sections together, and said support straps provide a means of securing the cart around the chest of a person, thereby enabling the cart to be carried as a backpack.

5. A method of deploying a collapsible, portable, hand-operated cart having a generally trapezoidal load supporting frame means including an upper frame section, a middle frame section, and a lower frame section, said upper frame section being interconnected to said. middle frame section by an upper set of unidirectional rearward pivoting hinges, said lower frame section being interconnected to said middle frame section by a lower set of unidirectional rearward pivoting hinges, said lower frame section including a support plate connected by hinge means to the distal end thereof, a wheel assembly connected rigidly to the distal end thereof, and a wheel kick plate attached to the rear side thereof and extending behind said wheel assembly, said middle frame section including at least one set of supporting straps capable of providing load support and a plurality of securing straps capable of securing objects to said cart, said upper frame section including a pair of handle means adapted to be rotatably positioned at the proximal end thereof to face frontward to function as handles or to face rearward to function as shoulder harnesses and a pair of positioning means adapted for securing said handle means in a fixed position thereto, said method comprising steps of:
disconnecting said supporting straps from across the chest of a person carrying said cart as a backpack and lifting said cart off from the shoulders of the person;
disconnecting said securing straps from around said lower frame section, said middle frame section, and said upper frame section of said collapsed cart;
uninstalling said positioning means, rotating said handle means by 180 degrees, and reinstalling said positioning means to secure said handle means to said upper frame section in a position adapted for pulling said cart once said cart is fully deployed;
extending said rigid frame by unfolding said upper frame section about said upper hinges and unfolding said lower frame section about said lower hinges;
pivoting said support plate about said hinge to extend frontward from said lower frame section.

6. The method according to claim 5, further comprising steps of:
placing said cart on the ground in a position whereby said handle means are facing downward and said support plate is facing upward;
dragging a game carcass onto said cart with an end of the carcass being supported by said support plate;
securing the carcass to said frame with said securing straps;
standing between said handle means facing away from said cart, gripping said handle means, and removing the carcass from a remote area by dragging said cart loaded with the carcass across rough and wooded terrain.

7. A method of transporting a collapsible, portable, hand-operated cart having a generally trapezoidal load supporting frame means including an upper frame section, a middle frame section, and a lower frame section, said upper frame section being interconnected to said middle frame section by an upper set of unidirectional rearward pivoting hinges, said lower frame section being interconnected to said middle frame section by a lower set of unidirectional rearward pivoting hinges, said lower frame section including a support plate connected by hinge means to the distal end thereof, a wheel assembly connected rigidly to the distal end thereof, and a wheel kick plate attached to the rear side thereof and extending behind said wheel assembly, said middle frame section including at least one set of supporting straps capable of providing load support and a plurality of securing straps capable of securing objects to said cart, said upper frame section including a pair of handle means adapted to be rotatably positioned at the proximal end thereof to face frontward to function as handles or to face rearward to function as shoulder harnesses and a pair of positioning means adapted for securing said handle means in a fixed position thereto, said method comprising steps of:
pivoting said support plate about said hinge to retract into said lower frame section;
collapsing said frame by folding said upper frame section about said upper hinges and folding said lower frame section about said lower hinges;
uninstalling said positioning means, rotating said handle means by 180 degrees, and reinstalling said positioning means to secure said handle means to said upper frame section in a position adapted for carrying said cart as a backpack once said cart is fully collapsed;
connecting said supporting straps around said lower frame section, said middle frame section, and said upper frame section of said collapsed cart;
lifting said cart onto the shoulders of a person as a backpack with said handle means serving as shoulder harnesses and connecting said supporting straps across the chest of the person.
